(19) United States
(12) Patent Application Publication
(10) Pub. No.: US 2005/0056126 A1
(43) Pub. Date: Mar. 17, 2005

(54) Cutting machining center

(76) Inventor: Heinrich Lutz, Dirlewang (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/892,466

(22) Filed: Jul. 16, 2004

(30) Foreign Application Priority Data
Jul. 18, 2003 (DE) 103 33 051.8

(51) Int. Cl. B23B 3/34

(52) U.S. Cl. 82/129

(57) ABSTRACT

The invention refers to a machine tool for the in particular cutting machining of work pieces. The machine tool carries at least two spindles. At least one of the spindles can move, in particular move back, axially to the spindle axis relatively to the other spindle.

The invention refers to a machining center for the in particular cutting machining of work pieces, the machining center having a machining unit which carries at least two spindles.

### BACKGROUND OF THE INVENTION

A machining center as mentioned above is sufficiently known as machining station in transfer lines with normally driven spindles via toothed belts or gears. The advantage of machining centers with several spindles is the fact that, while the work piece is positioned and clamped in the machining center, by the simultaneous engagement of several tools driven by the spindles a higher cutting performance is possible. The efficiency, respectively the performance, of such machining centers is accordingly higher.

However, it now turns out that, spindles arranged as a rule one beside the other cannot be arranged as close to each other as desired. The minimum distance of the two spindles one beside the other is defined by the width of the spindles. Of course, this condition has to be taken into consideration accordingly when machining the work pieces. If, for example, in a work piece, like for example a cylinder head, borings have to be bored which are close to each other, the second spindle does not machine the boring hole which is closest but, for example, only the next one or the one after the next one.

After a first machining has been finished by the two spindles the work piece is shifted relatively to the machining unit laterally for the next machinings by the same spindles.

In this case it may turn out then that in the edge region the second spindle does not act anymore on the work piece and perhaps collides with the work piece holding device or other machine parts, or with the edge region of the work piece as this may be wider than the distance of the borings.

It is furthermore known to design machining centers of this kind in such a way that the center with its various spindles machines several work pieces simultaneously and therefore a corresponding higher cutting performance is reached, however, necessarily this exists then always as an average only for several work pieces. With the known machining centers, however, an effective machining carried out with a high cutting performance is not possible with small work pieces.

### BRIEF SUMMARY OF THE INVENTION

It is an object of the invention to avoid a collision of at least one spindle with other machine parts in machining centers equipped with several spindles, if the spindle cannot be positioned anymore on the work piece for machining.

In order to solve this problem the invention comes from a machining center as described in the beginning and proposes that at least one spindle can move, in particular move back, relatively to another spindle axially to the spindle axis.

The invention achieves that the spindle which cannot interact with the work piece anymore, because it is, for example, shifted laterally so far to the side that it cannot act anymore on the work piece, but threatens to collide with the work piece carrier, is simply drawn back and is thus in any case out of engagement even with the machine parts. By means of the suggestion according to the invention it is possible to achieve a high cutting performance as simultaneously several spindles have to be engaged with the work piece, and the invention avoids safely that spindles not needed anymore do not collide with machine parts or the edge of the work piece.

However, the suggestions according to the invention also show additional surprising possibilities. The multiple spindle arrangement in the machining centers according to the invention is used preferably in order to carry out for example a number of borings in the same grid distance in a work piece. The suggestion according to the invention, however, cannot only be used for the purpose that the spindle arranged laterally is drawn back in order to avoid collisions, but it can also be used to simply switch off a spindle during machining, for example, because in the desired grid dimension just no other boring has to be executed.

Even if in this connection a boring is mentioned as an example for a machining the invention is in no way restricted to a boring. The invention can be used for every cutting machining or with other machining applications.

This additional possibility allows to carry out in the machining center according to the invention not only a machining in a desired grid dimension, but also machinings with a spindle in any way may be carried out where, for example, the other spindle is put back and safely does not act on the work piece.

In a preferred variant of the invention it is provided that the spindles are arranged in a common sleeve and the sleeve can be set against the work piece. The sleeve causes the spindle to move along the spindle axis, usually called Z-axis. The movement of the spindle in the sleeve has to be carried out here highly accurately as this movement leads directly to the result of the machining in the work piece. It is convenient here, as with the machining centers according to the invention preferably machinings in grid dimensions are carried out, to arrange the spindles in a common sleeve and thus to set them together against the work piece.

In another variant of the invention it is provided that on the machining unit at least two, preferably parallel orientated, sleeves are arranged each of them with two individual spindles. This arrangement also leads to a high flexibility as the spindles can be moved on the machining unit independently of each other. However, this means an increased effort, as an individual drive per sleeve has to be provided.

Furthermore it is an advantage that the distance of the spindles can vary. Usually machinings are carried out with a fixed grid dimension. However, in order to make a change, for example for the machining with another grid dimension, easier it is provided in a variant according to the invention also to vary the distance of the spindle, making it possible to use the machining center according to the invention even with work pieces with altered grid dimensions. Conveniently here at least one spindle is put on a mobile guide, which is preferably rectangular to the spindle axis, and thus the distance of the spindle is varied.

Furthermore the invention provides that the spindles are arranged on a common spindle sledge of the machining unit and the spindle sledge can be set against the work piece. Alternatively to the arrangement of the spindles in a common sleeve it is possible to provide a common spindle sledge for the movement of the spindles. In the solution with a common sleeve as well as in the solution with the spindle sledge it is provided according to the invention that at least one spindle can be retracted, respectively moved, with regard to the other spindle (both spindles are, however, on the sleeve, respectively the spindle sledge, and are set together against the work piece).

The result is that at least a first spindle is arranged fixedly in the sleeve or on the spindle sledge, at least a second spindle can be moved axially to the spindle axis in the sleeve or on the spindle sledge, in particular can be drawn back. This variant according to the invention solves the problem mentioned at the beginning with comparatively small effort.

In a preferred variant of the invention it is provided that the relation between the distance of the spindle axes and the spindle diameter is less than 2 and more than 1, preferably less than 1.5 and more than 1.01.

The construction according to the invention allows a very narrow arrangement of the two spindles, which are preferably designed similarly, that means they have the same spindle diameter. If it can be managed to chose the distance of the spindles, as provided in this variant according to the invention, correspondingly small the result is that even with comparatively small work pieces several spindles can be applied simultaneously, increasing the efficiency in the machining even of only one work piece accordingly. In the state of the art a comparatively high efficiency may be reached, however, for that purpose comparatively large machining centers had to be used, as it was not possible that the different spindles act on the same work piece simultaneously. By means of that the invention achieves a very effective use of space as in the narrow space a large density of spindles can be offered which leads to a high cutting performance and which can be used simultaneously, for example, for the machining of cylinder heads or cylinder blocks for automobile motors.

Therefore the invention can use successfully comparatively small spindle diameters, for example with a diameter of 200 mm or preferably of 150 mm which allow an efficient machining as described above. The result is that the first and the second spindle can machine the same work piece.

In a preferred embodiment of the invention it is provided that a connecting rod engages on the second, mobile spindle on the opposite side of the tool. This development according to the invention is convenient with regard to a distance of the axes of the spindles as small as possible. The drive for the backwards movement of the spindle engages on the spindle on the back on the side opposite to the tool. The axial drive provided for the movement of the connecting rod, for example a roller ball spindle drive, an electromotor or a hydraulic or pneumatic working cylinder or another axial drive are here also in the back region and does not widen the complete construction. This makes it possible to reach, as desired, a comparatively small distance of the spindle which is defined essentially only through the width of the spindles and their support on the spindle sledge, respectively on the sleeve.

Alternatively it is, of course, also possible to arrange the axial drive directly on the spindle, this means a disadvantage in the smaller distance between the two spindles. This reduces the overall length of the arrangement.

The machining unit has a guide in order to position the second mobile spindle as exactly as possible. The guide has to be in particular very accurate when the second mobile spindle is in the front position, that means in the position where the spindle can act on the work piece. For an operation as trouble-free as possible, naturally a guide as accurate as possible is also an advantage.

Preferably the machining unit has a centering flange which interacts with the spindle head of the second spindle in order to define the second spindle. The centering flange is eventually responsible for a highly accurate positioning and also orientation of the spindle axis of the second spindle. On the one hand, here the orientation of the axis, as well as, on the other hand, the axial position has to be defined exactly. Conveniently corresponding possibilities for adjustment have been created on the machining centers in this region in order to achieve a highly accurate adjustment.

In another improvement according to the invention it is provided that the centering flange is designed as a conical seat. The conical seat here has two advantages. The axial position of the spindle is exactly defined and a play necessary for the movement of the spindle is securely eliminated.

It has to be taken into consideration that the spindle rotates with a high speed. The determined first spindle has its abutment for the rotational movement in the determination of the spindle on the machining unit. That has still to be taken care of for the second mobile spindle. Conveniently for that a torsion safety device is provided which is, for example, realised in a simple manner by the engagement of a rail or a spring in a groove. The rail can here move in longitudinal direction in the groove in order to allow the axial movement of the second spindle. It is sufficient here that the torsion safety device acts exactly then when the second spindle is in the front position, that means it is used for machining purposes.

In a variant according to the invention it is also provided that the torsion safety device acts along the movement of the second spindle in the direction of the spindle. Therefore there is also a torsion safety device during the period of time when the spindle has not to be used directly for machining purposes. This makes sure that also the starting or the braking spindle can be moved securely, and the spindle is even safe against torsion during this period of time. As then the movements can be carried out also parallel, simultaneously, that means that the retraction movement is carried out parallel with the braking of the spindle, time is saved accordingly during the machining cycles which eventually increases the efficiency of the machining center according to the invention.

Naturally, the invention provides also a variant where a torsion safety device exists during the movement of the spindle in the spindle direction as well as a torsion safety device is active when the spindle is in the front position. Such an arrangement makes a torsion safety device available at any time of application.

In a preferred variant of the invention it is provided that the torsion safety device is formed by a sliding block guided in a groove. Here the groove is parallel to the spindle axis and forms a torsion safety device, in particular during the movement of the second spindle in the direction of the spindle. It is possible here to arrange either the groove or the sliding block movably at the spindle, and to form the other, corresponding element stationary. Both variants are possible according to the invention. Conveniently also a torsion safety device is integrated in the sliding block which becomes active when the second spindle is in its front position. This can be reached for example by inserting of the front part of the sliding block into a suitable torsion boring. Thus a simple and very efficient torsion safety device is provided for determining the spindle in its front machining position as well as during the movement of the spindle.

Conveniently a housing is provided for the second spindle on the machining unit and guides are arranged on its interior surface for the moved second spindle. Furthermore it is an advantage that an abutment for the axial drive is arranged on the housing. The housing is here sufficiently stable in order to form the abutment and to form simultaneously the guides. Conveniently the housing is here shaped like a cylinder, the bottom which is sufficiently stable forming the abutment for the axial drive. It has to be taken into consideration here that the axial drive develops a sufficient power as the advance of the sleeve, respectively of the spindle sledge, which carries the two spindles tries to press back the second spindle which is supported movably.

If necessary therefore on the axial drive, for example, a seal, a lock or a catch may be provided, in order to hold the second movable spindle securely in the front position. This lock may, however, be even arranged at another suitable point, for example, in the region of the flange. Alternatively it is possible that, for example, the axial drive is dimensioned sufficiently powerfully in order to cause locking.

Preferably a hydraulic or mechanic lock of the second spindle in the front position is provided. A hydraulic lock is used for example when the movement of the spindle is carried out anyway by means of a hydraulically acting working cylinder. Preferably then the working cylinder is designed double acting and the advance movement of the working cylinder is impinged with pressure, so that the spindle moves towards the centering flange and is thus locked. However, it is also possible to provide a corresponding mechanic lock. For that purpose, for example, suitable power assists like knuckle joint arrangements or the like have to be used which become active when the second spindle is in the front position. The lock has to be designed here in such a way that it guarantees in any case an exact dimensioning even if the machining forces act on the spindle and try to press it back.

It is convenient if at least parts of the housing are at least parts of the sleeve holding the spindle or spindle sledges carrying the spindles. Such an arrangement saves weight as the respective parts are assigned a double function.

Furthermore the invention provides that the machining unit has at least two groups with at least one or more spindles, and at least spindles of one group can be moved axially, in particular be moved back, relatively to the spindles of the other group. The invention is not restricted here to the movement, in particular the back movement of one spindle relatively to another spindle, but it can in the same way according to the invention also be used in a group of spindles. Conveniently here these spindles in one group are moved together.

It is an advantage that the second spindle which can move back can be retracted farther than the depth of the boring in the work piece or the advance path of the sleeve, respectively the spindle sledge, during the machining. This makes sure that the second spindle, if it is not needed, is therefore put back, is safely out of engagement—also during the machining.

In a preferred variant of the invention it is provided that the spindle has a direct drive. To put it differently it is provided that the spindle is designed as a motor spindle. This arrangement which is very space-saving allows driving the spindle with high speed, and, in contrast to the known belt drives or gear drives, such a direct drive does not lead to undesired concussions of the tool which could lead under circumstances to inaccurate dimensions in the machining. Simultaneously thus a space-saving arrangement is reached which is in particular convenient with the machining of smaller work pieces with high efficiency.

For a safe operation of the machining center according to the invention it is provided that the machining center has a cable trough, which moves together with the sleeve, respectively the spindle sledge, and is arranged on the back side of the spindle. In the cable trough all media lines necessary for the operation of the spindle, in particular electric connections, connections for coolants, compressed air and so on are inserted and guided in such a way that even a movement of the sleeve, respectively the spindle sledge, does not lead to undesired disturbances through, for example, fixed lines and so on.

As the second spindle is designed that it can move relatively to the sleeve, respectively the spindle sledge, it is convenient to provide on the back of the second spindle a cable guide which moves together with it, which eventually has the same effect analogously as the cable trough for the complete sleeve, respectively the spindle sledge. In this connection it is an advantage to provide a guide of the cable guide in the cable trough in order to support and guide the cable guide safely and reliably.

### BRIEF DESCRIPTION OF THE SEVERAL VIEWS OF THE DRAWINGS

In the drawing the invention is shown schematically. In the figures:

FIGS. 1, 6 each a top view of the spindles of the machining center according to the invention,

FIGS. 2, 5 each a view of another detail of the invention,

FIG. 3 a back view of the spindles of the machining center according to the invention,

FIG. 4 a top view of the front part of the machining center according to the invention.

### DETAILED DESCRIPTION OF THE PREFERRED EMBODIMENTS

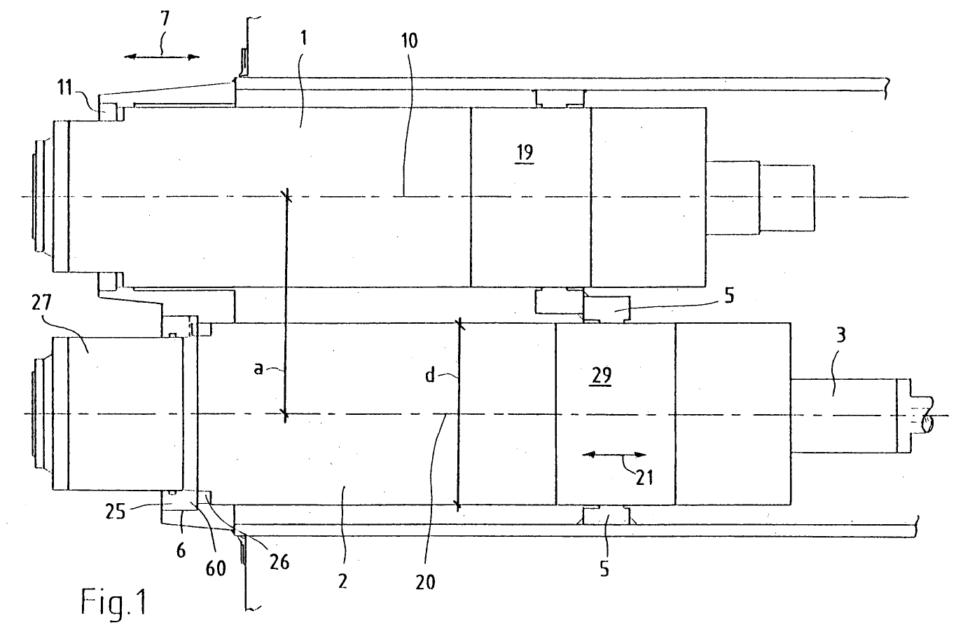

The invention is shown in FIG. 1. The machining center according to the invention is shown here only in a detail section, however, this is completely sufficient for the illustration of the invention. The machining center has several spindles 1, 2. They are preferably, for example, arranged in a common sleeve or on a common spindle sledge. The common movement of the spindles 1, 2 is indicated by the double arrow 7. This movement is made possible by the sleeve or the spindle sledge.

The first spindle 1, shown above in FIG. 1, is arranged stationary in the sleeve or on the spindle sledge. The spindle axis of the first spindle 1 is indicated by 10. For an exact orientation of the spindle axis 10 a centering flange 11 is provided which is screwed fixedly with the spindle in the front region.

The bottom second spindle 2 can move in the direction of the spindle axis 20. This indicated by the double arrow 21. This movement is reached by the connecting rod 3 engaging on the back end of the spindle 2. Guides 5 are provided for a movement of the spindle 2 as axial as possible. These guides 5 are arranged on the interior surface of the housing 23.

The spindle 2 is in the position shown here, this is in the front position, ready to work. In the retracted position the spindle head 27 is moved back so far that a tool mounted on the spindle head 27, however, not shown here, does not engage again with the work piece or threatens to collide with other machine parts or work piece carriers and so on.

In order to align the mobile second spindle 2 in the pushed forward position safely and reliably axially the spindle 2 has on its spindle head 27 another construction as the other spindle 1 mounted fixedly. A cone is provided on the spindle head 27. This cone interacts with the centering flange 25 which is part of the sleeve or the spindle sledge. The cone reaches a safe parallel alignment as well as also an axial positioning of the second spindle 2. In order to define the position exactly matching discs 26 are provided. These are used until the cone has no more play. Conveniently also on the matching disc 26 a torsion safety device is provided which has to resist the swivelling moment caused by the tool spindle.

In the centering flange 25 also a torsion safety device 6, 60 is provided. It may be, for example, formed by a groove which is suitably provided into which a nose, a rail or a spring grips in order to reach a torsion-resistant arrangement of the spindle 2 which can move axially.

In the example shown here the distance of the two spindle axes 10, 20 is indicated by a. The spindle axes 10, 20 are orientated parallel. The relation between the distance a of the spindle axes 10, 20 and the spindle diameter d is, according to the invention, less than 2, but more than 1, preferably less than 1.5 and more than 1.01. In the example shown here the relation is approximately 1.2. However, also constructions are known where the distance a equals 156 mm and the diameter of the spindle used 150 mm. In this case the relation is 1.04!

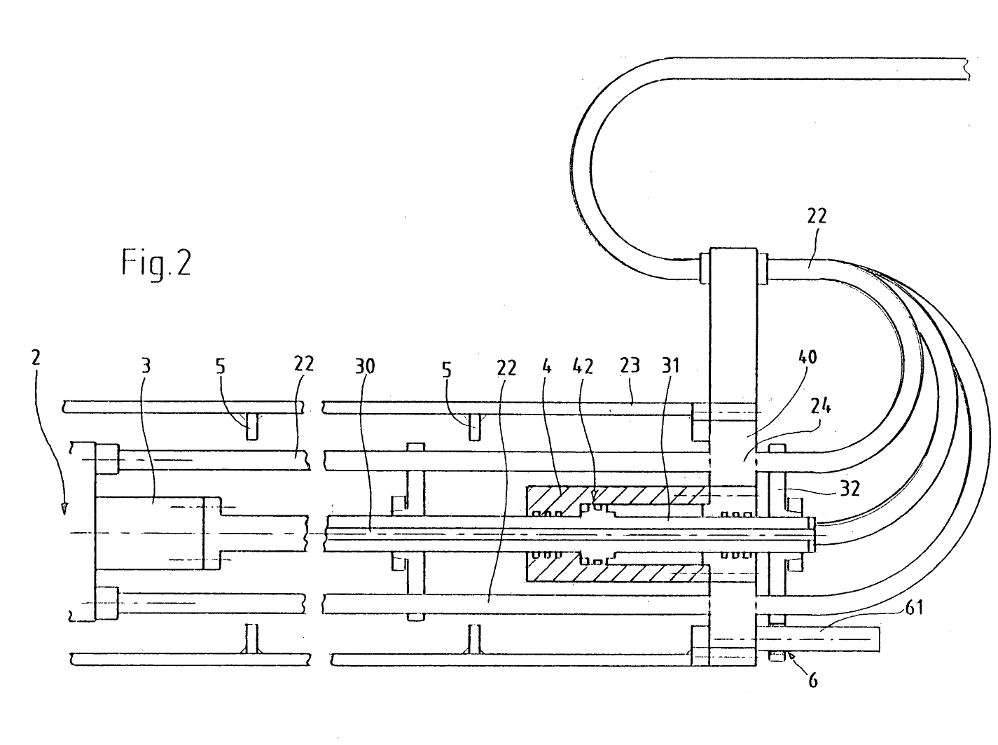

For moving the second spindle 2 a connecting rod 3 is provided on which an axial drive 4 acts. This is shown, for example, in FIG. 2. On the backside of the spindles 1, 2 several lines 22 are connected. They may feed coolants as well as lubricating liquids, for example for cooling and greasing the tool. The cooling serves for carrying away the heat in the spindle. Also electric lines, for example for the spindle drive, or control lines are provided.

FIG. 2 shows in sections only the conditions in the back region of the second spindle. For clearness purposes the back region of the first spindle 1 is not shown. The axial drive 4 acts, as indicated, on the connecting rod 3. In the example illustrated here the axial drive 4 is designed as hydraulic working cylinder 42. The connecting rod 3 forms the piston rod 31 in the working cylinder 42. The piston is located on the piston rod 31 and is impinged by hydraulic liquid and therefore moves. It is evident that the working cylinder is positioned exactly in order to reach a movement as accurate as possible of the second spindle 2. Conveniently the connecting rod is supported on several points. It is an advantage that a housing 23 is provided which embraces the spindle 2 like a cylinder. On the interior surface of this housing 23 guides 5 are provided for the spindle 2. At the same time the guides are designed in such a way that they result in a stiffening of the housing 23. If necessary, the guide 5 serves also as a guide for mounting.

Conveniently a boring 30 is provided in the piston rod 31. Through this boring also coolant is fed into the spindle 2.

The housing 23, which is, if necessary, also part of the sleeve of the two spindles 1, 2 has a housing bottom 24. This housing bottom 24 serves simultaneously also as abutment 40 for the axial drive 4. The piston rod 31 is guided out through the housing bottom 24 and carries on its external side a crossbeam 32. The crossbeam 32, on the other hand, has a torsion safety device which, if necessary, acts inaccurately, which, however, is active during the complete lifting movement, respectively retraction movement, of the second spindle 2. This torsion safety device 61 is arranged in the bottom region. Furthermore the crossbeam 32 serves for fixing the tubes and cables 22.

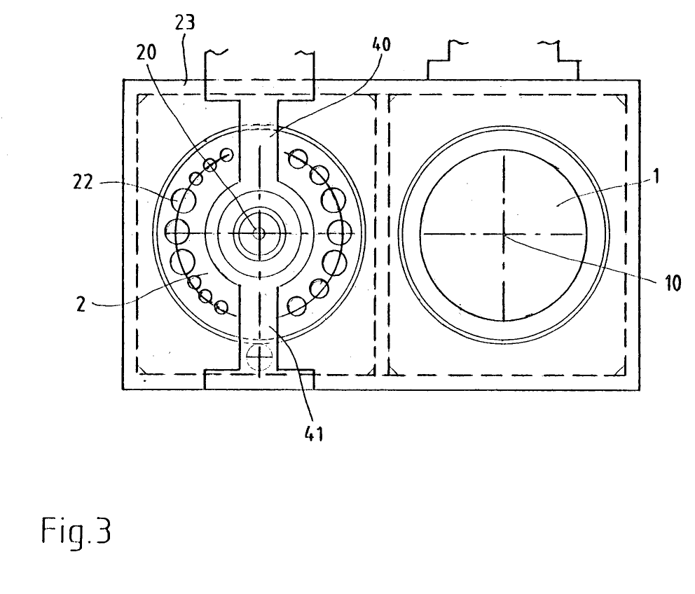

Furthermore in FIG. 3 also a view from the back is shown. The housing 23 is essentially square or rectangular. It holds the two spindles 1, 2. The axial drive 4, here a hydraulically working cylinder, is connected with the housing 23 via the fastening device 41. In this embodiment the fastening device 41 is simultaneously the abutment 40. However, even two independent elements may be provided.

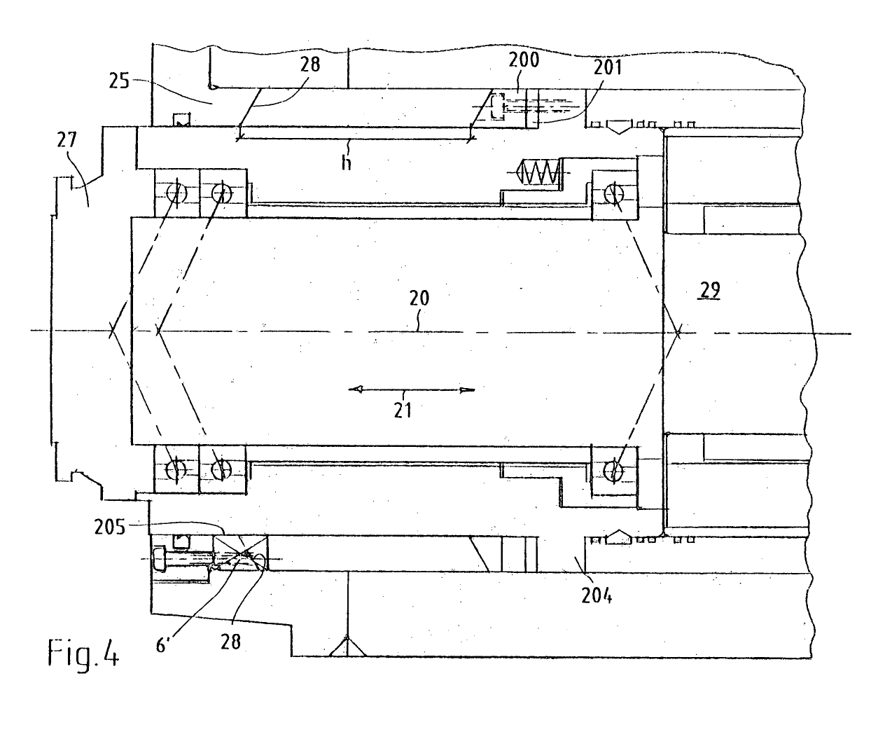

In FIG. 4 the front part of the spindle of another embodiment of a machining center according to the invention is shown. The centering flange 25 is in the embodiment shown here designed as conical seat 28. The spindle 2 can move along the length of the stroke h in the direction of the spindle axis 20. A stop ring 200 is provided on the spindle. For an exact adjustment of the position a matching disc 201 is located between the stop ring 200 and the shoulder 204. In the region of the spindle head 27 a guide 205 is provided. All guides are equipped in this region with sufficient play so that the spindle can be moved. However, if the stop ring 200 runs against the conical seat 28 the play is eliminated and an exact position of the spindle head 27 is determined. It is a considerable advantage here that the conical seat 28 is relatively close to the spindle head 27 in order to suppress corresponding dimensional tolerances, thermal expansions and inaccuracies firsthand. Instead of the conical seat 28 shown here according to the invention it is, of course, also provided to use all other known arrangements of centering flanges.

The spindle 2 shown in the example according to FIG. 4 is designed as motor spindle, in the back region, opposite the spindle head 27 on the spindle axis 20 a driven motor 29 is provided. The expensive, space-consuming construction with an external gear or a toothed belt drive is avoided with the moved spindle 2 as well as with the stationary spindle 1 (see here motor 19).

In the example shown in FIG. 4 a torsion safety device 6′ is realised. Similar to FIG. 1 in the front region a torsion safety device 6′ is provided, which is here also built in in the conical seat 28. The stop ring 200 has a nose for that purpose which engages in a holding way in a corresponding recess in the conical seat 28 and thus results in a torsion safety device. Of course, vice versa the stop ring 200 may have a recess and the conical seat 28 a nose. This torsion safety device 6′ is in particular active in the front position of the spindle 2. Furthermore, however, another torsion safety device 6 is provided, as shown in FIG. 2. By means of that the arrangement gains also a torsion safety device 6, which is also active during the retraction movement, that is during the complete shifting path. The invention leaves it open to combine one, two or more different torsion safety devices with each other.

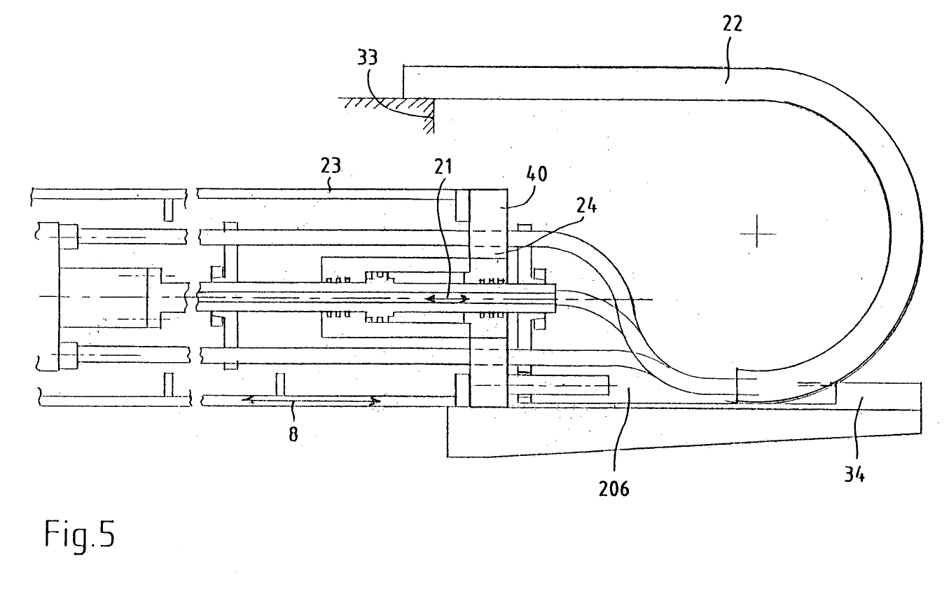

FIG. 5 shows that the movement 21 of the spindle 2 is smaller than the large stroke movement 8 of the complete sleeve, respectively the complete tool sledge. This is expressed by the different lengths of the respective double arrows 8, 21. Furthermore a cable trough 34 is provided which moves together with the sleeve, respectively the spindle sledge, and is arranged on the backside of the spindle 1, 2. It serves for a safe guide of the lines 22. Conveniently (however not compulsory) the lines 22 are bedded, for example, in so-called energy guide chains which themselves are determined, for example, on the fixing point 33, for example, on the housing 23 of the spindle or the sleeve. As the second spindle 2 may move relatively to the sleeve (see double arrow 21) it is provided that for guiding the spindle 2 furthermore a cable guide 206 is provided which is arranged on the side of the second spindle 2 and moves together with it.

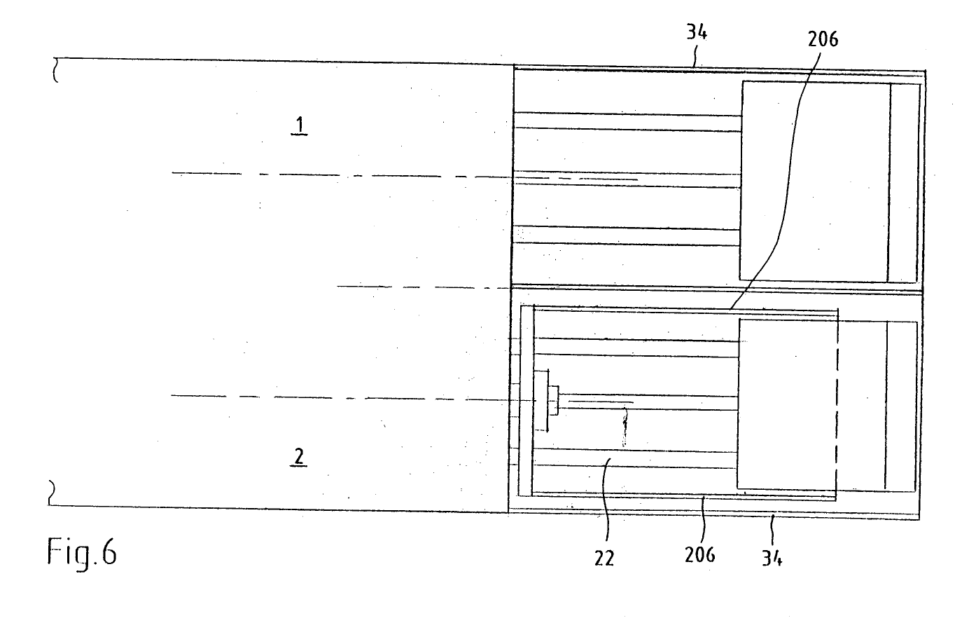

In FIG. 6 it is shown again how another cable guide 206 within the cable trough 34 is arranged on the movable spindle 2 besides the cable trough 34. Conveniently a guide is provided for the movement of the cable guide 206 in the cable trough 34.

Although the invention has been described by exact examples which are illustrated in the most extensive detail, it is pointed out that this serves only for illustration and that the invention is not necessarily limited to it because alternative embodiments and methods become clear for experts in view of the disclosure. Accordingly changes can be considered which can be made without departing from the contents of the described invention.

The claims filed with the application now and to be filed later on are attempted formulations without prejudice for obtaining a broader protection.

If here, on closer examination, in particular also of the relevant prior art, it turns out that one or the other feature may be convenient for the aim of the invention, however, not decisively important, of course already now a formulation is striven for which does not contain anymore such a feature, in particular in the main claim.

References in the sub-claims relate to the further design of the matter of the main claim through the characteristics of the respective sub-claim. These are, however, not to be understood as a waiver of independent protection of the matter for the characteristics of the referred sub-claims.

Characteristics only disclosed in the description now, may, in the course of proceedings, be claimed as being of inventive relevance, for example to distinguish from the prior art.

Characteristics only disclosed in the description or even single characteristics from claims which comprise a variety of characteristics may be used at any time to distinguish from the state of the art in the first claim, and this is even if such characteristics have been mentioned in connection with other characteristics, respectively achieve particular convenient results in connection with other characteristics.

1. Machining center for the in particular cutting machining of work pieces, the machining center having a machining unit which carries at least a first (1) and a second spindle (2), characterised in that at least the second spindle (2) can move, in particular move back, relatively to the first spindle (1) axially to the spindle axis (20) in the direction (21) of the spindle.

2. Machining center according to claim 1, characterised in that the spindles (1, 2) are arranged in a common sleeve or on a common spindle sledge of the machining unit, and the sleeve, respectively the spindle sledge, can be set against the work piece.

3. Machining center according to claim 1, characterised in that at least a first spindle (1) is arranged fixedly in the sleeve or on the spindle sledge, and at least a second spindle (2) can move (21), in particular move back, in the sleeve or on the spindle sledge axially to the spindle axis (20).

4. Machining center according to claim 1, characterised in that the relation between the distance (a) of the spindle axes (10, 20) and the spindle diameter (d) is less than 2 and more than 1, preferably less than 1.5 and more than 1.01.

5. Machining center according to claim 1, characterised in that the spindle diameter (d) is up to 200 mm, preferably about 150 mm.

6. Machining center according to claim 1, characterised in that the first and the second spindle (1, 2) are able to machine the same work piece.

7. Machining center according to claim 1, characterised in that on the second movable spindle (2) a connecting rod (3) engages on the side opposite to the tool.

8. Machining center according to claim 1, characterised in that on the second movable spindle (2) a connecting rod (3) engages on the side opposite to the tool, and a roller ball spindle drive, an electro-motor, a hydraulic or pneumatic working cylinder or another axial drive (4) is provided which acts on the connecting rod (3) in order to move the second spindle (2).

9. Machining center according to claim 1, characterised in that the machining unit has a guide (5) for the second movable spindle (2).

10. Machining center according to claim 1, characterised in that on the machining unit a centering flange (25) is provided which interacts with the spindle head (27) of the second spindle (2) in order to define the second spindle (2).

11. Machining center according to claim 1, characterised in that on the machining unit a centering flange (25) is provided which interacts with the spindle head (27) of the second spindle (2) in order to define the second spindle (2) and the centering flange is designed as conical seat.

12. Machining center according to claim 1, characterised in that on the second movable spindle (2) on the side opposite to the tool a connecting rod (3) engages and the connecting rod (3) has a boring (30) for the flow of coolant.

13. Machining center according to claim 1, characterized in that on the machining unit at least one torsion safety device (6) is provided for the second spindle (2).

14. Machining center according to claim 1, characterised in that on the machining unit at least one torsion safety device (6) is provided for the second spindle (2) and the torsion safety device (6) acts along the movement of the second spindle (2) in the direction (21) of the spindle and/or acts then when the second spindle (2) is in the front position.

15. Machining center according to claim 1, characterised in that on the machining unit at least one torsion safety device (6) is provided for the second spindle (2) and the torsion safety device is formed by a sliding block guided in a groove.

16. Machining center according to claim 1, characterised in that for the second spindle (2) on the machining unit a housing (23) is provided and on its interior surface guides (5) are arranged for the moved second spindle (2) and on the housing (23) an abutment (40) is arranged for the axial drive (4).

17. Machining center according to claim 1, characterised in that for the second spindle (2) on the machining unit a housing (23) is provided and on its interior surface guides (5) are arranged for the moved second spindle (2) and on the housing (23) an abutment (40) is arranged for the axial drive (4) and at least parts of the housing (23) are at least parts of the sleeve holding the spindles (1, 2) or of the spindle sledges carrying the spindles (1, 2).

18. Machining center according to claim 1, characterised in that the machining unit has at least two groups with at least one or more spindles (1, 2) and at least spindles (1, 2) of one group can move axially, in particular move back, relatively to spindles (1, 2) of the other group.

19. Machining center according to claim 1, characterised in that the second spindle (2), which can move back, can move back farther then the depth of the boring in the work piece or the shifting path of the sleeve, respectively the spindle sledge, during machining.

20. Machining center according to claim 1, characterised in that the distance of the spindles (1, 2) can vary.

21. Machining center according to claim 1, characterised by a lock of the second spindle (2) in the front position.

22. Machining center according to claim 1, characterised in that a hydraulic or mechanic lock of the second spindle in the front position is provided.

23. Machining center according to claim 1, characterised by a direct drive (19, 29) of the spindles (1, 2).

24. Machining center according to claim 1, characterised by a cable trough (34) which moves together with the sleeve, respectively the spindle sledge, and is arranged on the back side of the spindles (1, 2).

25. Machining center according to claim 1, characterised by a cable guide (206), which is arranged on the back side of the second spindle (2) and moves together with it.

26. Machining center according to claim 1, characterised by a cable trough (34), which moves together with the sleeve, respectively the spindle sledge and is arranged on the backside of the spindles (1, 2), and a cable guide (206), which is arranged on the backside of the second spindle (2) and moves together with it, and a guide of the cable guide (206) in the cable trough (34).
